(19) United States
(12) Patent Application Publication
(10) Pub. No.: US 2020/0346058 A1
(43) Pub. Date: Nov. 5, 2020

(54) Component for a Fire Protection System, Method for Producing the Same and Fire Protection System Comprising the Same

(71) Applicant: Minimax GmbH & Co. KG, Bad Oldesloe (DE)

(72) Inventors: Peter KEMPF, Bad Oldesloe (DE); Frank STACHOWITZ, Ratzeburg (DE); Jan STARK, Bad Oldesloe (DE)

(21) Appl. No.: 16/962,722

(22) PCT Filed: Jan. 17, 2019
(86) PCT No.: PCT/EP2019/051109

§ 371 Date: Jul. 16, 2020

(30) Foreign Application Priority Data
Jan. 17, 2018 (DE) 10 2018 100 983.6

(51) Int. Cl. A62C 31/05; A62C 99/00; A62C 35/68; A62C 31/28

(52) U.S. Cl. CPC A62C 31/05; A62C 31/28; A62C 35/68; A62C 99/0072

(57) ABSTRACT

The invention relates to a component (1, 1′, 1″, 1′″, 2) for a fire protection system, in particular a fire extinguishing system having a housing (11, 21). In accordance with the invention, at least one nozzle (10, 20, 3, 3′) for dispensing extinguishing fluid onto the component (1, 1′, 1″, 1′″, 2) is arranged on the housing (11, 21) or in the vicinity of the housing (11, 21), the nozzle (10, 20, 3, 3′) being connectable to a supply of extinguishing fluid.

### PRIORITY CLAIM AND INCORPORATION BY REFERENCE

This application is a 35 U.S.C. § 371 application of International Application No. PCT/EP2019/051109, filed Jan. 17, 2019, which claims the benefit of German Application No. 10 2018 100 983.6, filed Jan. 17, 2018, each of which is incorporated by reference in its entirety.

### TECHNICAL FIELD

The present invention relates to a component for a fire protection system having a housing.

### BACKGROUND AND SUMMARY OF THE INVENTION

Fire protection systems of the kind described above are known. Such fire protection systems may include, without limitation, fire extinguishing systems, spark extinguishing systems, fire alarm systems, smoke venting systems and/or a combination of these. In this context, fire extinguishing systems are to be understood as corresponding to permanently operational systems which serve to distribute extinguishing agents and use such agents to extinguish fires that have already started.

Spark extinguishing systems, on the other hand, are used for preventive fire protection and detect and neutralize potential ignition sources before the fire even starts. For this purpose, spark extinguishing systems have so-called spark detectors, which record the heat radiation emitted by the sparks or other ignition sources and thus detect them. If sparks or other ignition sources are detected, the spark detectors then send a corresponding signal to a radio alarm center of the spark extinguishing system. The radio alarm center then initiates the extinguishing process.

Fire alarm systems are also used for preventive fire protection. Fire alarm systems usually comprise a fire alarm center and one or more fire detectors which are used to detect fire events. These fire detectors may be designed as combustion gas or flue gas detectors, as smoke detectors, as flame detectors and/or as heat detectors.

In response to the detection of a (potential) fire event, the fire alarm center receives a corresponding signal from the one or more corresponding fire detectors. The fire alarm center then causes the fire alarm system to issue a hazard alarm. In response to such a hazard alarm, a number of different measures may then be taken, such as triggering an alarm, alerting a fire department, closing fire protection barriers, triggering an extinguishing system or similar. In this way, fires or ignition sources can be detected early, even at locations where no persons are present at that time. Further spread can thus be prevented, if necessary.

Smoke venting systems are used to vent smoke produced in the event of fire from the inside of a building to the outside. Smoke venting systems can be triggered manually and/or automatically by the above-mentioned fire detectors and/or the fire alarm system. Alternatively or in addition, triggering can also be effected by thermal triggers, i.e. temperature-sensitive elements. Typically, it should particularly be possible to trigger smoke venting systems manually. An automatic trigger mechanism can be added, depending on the requirements for the smoke venting system.

All these systems have in common that they serve fire protection, in particular the prevention and/or containment of fires. In the event of such fires, heat is usually generated in the area of the fire protection system. It is a fundamental necessity that the fire protection systems continue to function reliably despite the generated heat. This requires in particular that certain components of the fire protection system maintain their functionality even at high temperatures.

Such components for a fire protection system may particularly be components installed within the fire protection system, especially water-carrying components of a fire protection system, such as valves or the like. Alternatively or additionally, such components may also be electronic components used for the control of the fire protection system or for comparable applications. The electronic components are preferably encased so that the electronics are not damaged when an extinguishing process is initiated. In particular, these may be encased electronic components which are located within the space in which the fire protection system is installed. As a first example, electronic cabinets should be mentioned here, in which circuits or similar, which serve for example to control the fire protection system and which should therefore retain their functionality even in the event of fire, are located. Another example are cooling systems, which are used, for example, to cool electronics or other elements, and for which it is also advantageous to retain their functionality in the event of fire.

It is common practice to manufacture such components from materials or to encase them with materials that have a very high melting temperature, in order to ensure their heat resistance. The materials to be used for this purpose are specified in particular by corresponding standards and guidelines, for example, fire protection standards for stationary extinguishing systems such as the VdS CEA 4100 guidelines, which must be complied with during the manufacture and/or encasing of the components. Common materials used to manufacture a housing or casing for these components include cast iron or brass. The connecting pieces, in particular pipes, between the components and the fire alarm system are typically made of steel.

These materials have a high melting temperature and thus a high heat resistance, and they are also characterized by high strength. This combination of high melting temperature and strength makes the materials mentioned particularly suitable for use in fire protection systems.

A disadvantage of these materials, however, is their high specific weight. Especially larger components usually have a very high dead weight due to the high specific weight of the material from which they are made. This means that the production of the components from these materials is relatively costly and that the handling of the components during transport, installation and/or maintenance is also more difficult. This increased effort during manufacture and/or transport causes an increase in such components' manufacturing and distribution costs.

A further disadvantage of the commonly used materials is their susceptibility to corrosion. This means that, after their manufacture, the components must be additionally coated with an anticorrosive agent, which requires a further step in the manufacturing process and additional material costs. This increases the manufacturing costs even further.

It is therefore desirable to replace the materials currently used with materials that do not have these disadvantages. Against this background, the object of the invention is thus to further develop the above-mentioned components for a fire protection system in such a way that they can be manufactured and transported more efficiently and at lower cost, as well as handled more easily during installation, maintenance and/or transport.

The invention achieves its object in a first aspect by arranging at least one nozzle for dispensing extinguishing fluid onto the component on the housing or in the vicinity of the housing, the nozzle being connectable to an extinguishing fluid supply.

The invention is based on the realization that there already are a large number of materials which have a lower specific weight compared to the materials normally used for the above-mentioned components, while at the same time having comparable properties in terms of strength. However, the required melting temperatures of these lighter materials are too low for such materials to be used for the production of components for fire protection systems.

In this respect, it was recognized that the problem of the lower melting temperatures of lighter materials can be avoided by equipping such components with a self-protection mechanism in the form of a nozzle for dispensing extinguishing fluid against the heat generated in a fire. The dispensing of extinguishing fluid cools the component in the event of fire, which can prevent the component from melting, even if it is made of a material with a lower melting temperature than that of previously common materials. According to the invention, it is preferred, in this respect, that the temperatures at the component in the event of fire are to be kept below a threshold of 200° C. in particular, and even more preferably below a threshold of 100° C.

For this purpose, it is necessary to dispense the extinguishing fluid from the nozzle with the corresponding operating pressure and in the corresponding quantity. Depending on the nozzle, the operating pressure should be above 5 bar, preferably above 10 bar, even more preferably above 15 bar. For example, a K40 sprinkler could be used as a nozzle. At an operating pressure of 16 bar, 160 liters of extinguishing fluid per minute can emerge from the sprinkler. Such a quantity should be sufficient to cool the component equipped with the nozzle (the K40 sprinkler) to below 100° C.

According to the invention, it is preferred that, in the event of fire, an extinguishing fluid emerges through the nozzle. Because the nozzle is arranged on the housing or in the vicinity of the housing, the extinguishing fluid discharged through the nozzle is directly incident on the component or the housing of the component. The extinguishing of fire sources on or in the vicinity of the housing reduces the heat generated by the fire source and prevents melting and/or deformation of the component or the housing of the component. As a result, materials with a lower melting temperature, such as light metals or plastics, can also be used for the components.

A nozzle according to the invention is to be regarded as any type of protective element from which an extinguishing fluid with predetermined performance characteristics can flow out. In particular, the nozzle may be implemented as a sprinkler or an extinguishing nozzle. The nozzle may preferably be designed as an upright sprinkler, which is arranged on the housing of the component.

In this context, the term sprinkler is to be understood as referring to a sprinkler head. Such sprinkler heads are supplied with extinguishing fluid by a fluid supply, usually a sprinkler system. In the normal state, the sprinklers are sealed with a temperature-sensitive element such as a glass ampoule filled with a liquid. In the event of fire, the liquid inside the glass ampoule heats up and expands. The ampoule bursts, causing the sprinkler to open and allowing the extinguishing fluid to emerge. The nozzle can also be implemented as an extinguishing nozzle. Such extinguishing nozzles are typically arranged on extinguishing fluid supply lines such as pipes. By feeding an extinguishing fluid into the extinguishing fluid supply line, the extinguishing nozzle is pressurized with the extinguishing fluid and thus triggered. Extinguishing nozzles are typically used in spark extinguishing systems.

In some embodiments, the triggering can also be effected by a temperature gauge, which determines the temperature at and in the vicinity of the nozzle and/or component and triggers at a certain temperature. The trigger temperature can preferably correspond to the trigger temperature of the extinguishing fluid outlets of the fire protection system. In some embodiments, the trigger temperature is between 60 and 70° C. Alternatively or additionally, the trigger temperature may also be below or above the trigger temperature of the extinguishing fluid outlets of the fire protection system.

In some embodiments, the triggering of at least one nozzle may also be triggered by means of an electronic circuit. Here, the electronic circuit is preferably configured in such a way that it transmits a corresponding signal to the nozzle if it is determined that cooling of the component is necessary. The nozzle can then be triggered in response to the signal.

According to the invention, the nozzle may be arranged directly on the housing of the component. This can be done directly during the manufacturing process, where the nozzle is attached to the housing during manufacturing. Alternatively, it is also possible to retrofit a housing with such a nozzle, for example in order to retrofit a component with fire protection.

Alternatively, the nozzle may be arranged in the vicinity of the housing. In this respect, the vicinity should be selected in a manner as to ensure that the extinguishing fluid dispensed through the nozzle gets onto the component which is to be protected by the nozzle. Furthermore, the extinguishing fluid should be able to get to the area around the component, especially the area below the component. In this respect, the vicinity is to be selected in such a manner that it comprises the area in which it can be ensured that the component is cooled by the extinguishing fluid emerging from the nozzles in such a way that the component, or its housing, can be made of a material which has a melting temperature below 800° C. The nozzles should thus be arranged in such a way that they can provide sufficient cooling of the component at that level. For this purpose, the vicinity comprises in particular an area of 1 to 100 cm around the housing. This means that the nozzle is arranged at a distance of 1 to 100 cm from the housing.

Preferably, the vicinity covers a range of 1 to 50 cm. The advantage of mounting the nozzle at a maximum distance of 50 cm from the housing is that, at this distance, a very good distribution of the extinguishing fluid over the entire component can be achieved since the extinguishing fluid can spread on its way from the nozzle to the component.

Even more preferably, the vicinity covers a range of 1 to 20 cm around the housing. The advantage of this preferred design, in which the nozzle is positioned at a maximum distance of 20 cm from the housing, is the good adjustability of the extinguishing surface of the extinguishing fluid. This means that, at a maximum distance of 20 cm, the adjustment of the nozzle in such a way that the extinguishing fluid can be distributed as evenly as possible over the component is greatly facilitated. In particular, depending on the desired adjustability and the space available, the nozzle may be arranged at a distance of 1 or 2 cm from the housing, or at a distance of 3, 4, 5, 6, 7, 8, 9 or 10 cm, or at any distance between 10 and 20 cm.

The extinguishing fluid discharged through the nozzle may be an extinguishing liquid, such as water, or water with additives (e.g. foam). Alternatively, the extinguishing fluid may be gaseous or a mixture of a gas and a liquid. In a specific embodiment, the extinguishing fluid may comprise perfluoro(2-methyl-3-pentanone) (C6F120). The advantage of this extinguishing fluid is that it may also be used to extinguish metals or similar.

According to the invention, the dispensing of the extinguishing fluid serves both to cool the component and to fight the fire. This means, on the one hand, that the extinguishing fluid applied to the component and distributed in the vicinity of the component effects a reduction in the temperature of the component—in particular of the housing—and, on the other hand, that the extinguishing fluid (thereafter) applied to the fire, which before or at the same time is used to cool the component, effects firefighting in the area of the component. In some embodiments, the effect of the extinguishing fluid is such that there is a ratio of 60% cooling to 40% firefighting.

To ensure satisfactory cooling and firefighting, it is advantageous to apply the extinguishing fluid for a certain time on the component and in the vicinity of the component. This time may depend in particular on the type and spreading of the fire event.

In an advantageous further design of the invention the housing is wholly or partly formed from a material with a melting temperature of less than 800° C. In another, preferred embodiment, the housing is wholly or partly formed from a plastic and/or light metal.

Preferably, the housing of the component is wholly or partly manufactured from a material that has a melting temperature of less than 800° C. Materials that have the lowest possible specific weight and high strength are particularly suitable for this purpose. Plastics and/or light metals that meet these weight and strength requirements are considered particularly advantageous in this context.

The advantage of using a plastic and/or light metal for the whole or partial manufacture of the housing is that these materials are very easy to manufacture and do not require any additional corrosion protection. Furthermore, these materials have a lower specific weight, so that the housings made from them for the components also have a lower weight compared to the prior art. This facilitates handling during transport, installation and maintenance. The use of a plastic and/or a light metal can thus reduce the costs and effort of manufacture as well as the costs of transport and the effort of installation.

A particularly preferred plastic for manufacturing the components for a fire protection system is a material from the group of polyamides having a glass fiber content. Polyamides in a fiber composite with glass fibers have very good mechanical properties. In particular, by adapting the fiber composite, the strength and impact resistance of this combination can be specifically adapted to the application.

Aluminum is a light metal suitable for use in a component for a fire protection system, for example, but other light metals such as titanium may also be used. In a preferred embodiment, the component for a fire protection system is manufactured from aluminum and water is used as the extinguishing fluid. In the event of fire, the component is cooled accordingly by applying water through the nozzles, preferably to below 100° C., and melting of the component is prevented.

Shaping the housing for the component from the material, in particular the plastic and/or light metal, can be achieved by a variety of methods by which the material can be formed into the desired shape. Examples of such methods are casting, bending, printing, milling, joining or similar. Here, shaping also comprises the provision of housing openings and housing connections for connecting to other components, for example components of the fire protection system. For example, the shaping of the housing can be carried out using a method from the casting group. For this purpose, different casting methods such as mold casting, ingot casting, continuous casting or similar may be used. In mold casting, filling the mold may be accomplished by gravity casting, centrifugal casting or pressure die casting, depending on the desired result and available production facilities. The shaping of the housing can also be carried out using a method from the bending group. Here too, different bending methods such as air bending, bottoming, roll bending, sheet metal bending or similar are applicable.

Alternatively or in addition, the shaping of the housing can also be carried out by means of additive manufacturing. For this, a digital 3D design is used to construct the housing layer by layer by depositing material. The advantage of this manufacturing process is the reduced material cost, because instead of, for example, cutting pieces out of a block to create openings and ducts, the ducts are built layer by layer from the outset.

In a further preferred embodiment, the component comprises an extinguishing fluid inlet, which is connected to the nozzle in a fluid-conducting manner.

An extinguishing fluid inlet within the meaning of the invention is to be understood as referring to any inlet for the extinguishing fluid. This extinguishing fluid inlet is preferably used to supply the nozzle. The inlet may be implemented as an opening in the housing of the component, the fluid-conducting connection being provided by a fluid-conducting duct inside the housing or alongside the housing. The extinguishing fluid inlet may also be equipped with a seal and a connecting piece. Thereby, a fluid-tight connection to an extinguishing fluid supply, e.g., of a fire extinguishing system or a separate supply system, can be ensured.

Preferably, the extinguishing fluid inlet is arranged on the housing of the component and the duct for the fluid-conducting connection between the extinguishing fluid inlet and the nozzle runs inside the component. This design is particularly advantageous in the case of fluid-conducting components for the fire protection system. These fluid-conducting components usually already have an extinguishing fluid inlet for the fluid line. By further configuring this extinguishing fluid inlet to supply the nozzle with extinguishing fluid, the number of housing openings of the housing for the component may be reduced, thus reducing the manufacturing effort. In some embodiments, the nozzle may also be supplied with extinguishing fluid directly from the extinguishing fluid supply of the component. Alternatively or in addition, the supply may be provided by the fluid duct running inside or outside the component, which establishes the fluid-conducting connection between the extinguishing fluid inlet and the nozzle. In some embodiments, the fluid duct also serves to connect the extinguishing fluid supply of the component to the nozzle.

It is also preferred that the extinguishing fluid inlet is arranged on the housing of the component or directly on the nozzle, such that the duct for the fluid-conducting connection between the extinguishing fluid inlet and the nozzle runs outside the component. In this case, the duct for the fluid-conducting connection may be provided, for example, by a pipe running outside the component or a hose located outside the component. This embodiment is particularly advantageous for components that are not fluid-conducting and for which it is not desirable for the extinguishing fluid to enter the interior of the component, such as electronic components.

According to a preferred embodiment, the nozzle comprises a plurality of nozzle outlet openings, at least one triggering device and an alignment element, where the plurality of nozzle outlet openings are arranged in a geometrically predetermined arrangement on the alignment element.

It is preferable that the nozzle can dispense the extinguishing fluid as evenly as possible onto the housing and into the area around the housing. Such even dispensing can be achieved in particular by the nozzle comprising a plurality of nozzle outlet openings from which the extinguishing fluid can be dispensed.

These nozzle outlet openings are arranged in a geometrically predetermined arrangement on the nozzle. In this context, the term geometrically predetermined is to be understood as meaning that the nozzle outlet openings are arranged according to a predetermined pattern on the alignment element. This pattern preferably determines the distance between the individual nozzle outlet openings, the number of nozzle outlet openings on the alignment element, and at which position of the alignment element the nozzle outlet openings are arranged.

In this respect, the nozzle outlet openings may be aligned in particular towards a floor surface and/or towards a ceiling surface and/or towards a side wall of a room. The nozzle outlet openings may thus be arranged at the top and/or bottom and/or sides of the alignment element—and thus the nozzle. The alignment element may in particular be selected such that the nozzle outlet openings are aligned in different directions, i.e. towards the top and/or bottom and/or to the sides.

In this respect, the arrangement of the nozzle outlet openings and the shaping of the alignment element may preferably be carried out in dependence on the component to be protected, i.e. cooled, since different components can have different geometries and thus require different outlet characteristics for the extinguishing fluid in order to be able to cool the component efficiently. Since the alignment element and the geometrical arrangement of the nozzle outlet openings determine the directional characteristic of the extinguishing fluid for the nozzle, they should always be selected in such a way that they allow for optimum extinguishing fluid application to the component to be protected.

In some embodiments, the alignment element is arranged on or in the vicinity of the housing. In particular, the alignment element may be implemented in such a way that it can be attached to an extinguishing fluid supply line of the component. In these cases, the alignment element is preferably ring-shaped. In some embodiments, the geometry of the alignment element may also be rectangular, triangular or similar rather than ring-shaped. In this respect, the geometry should always be determined with regard to the geometry of the component to be protected and the position where the alignment element is to be attached. In some embodiments, the position of the alignment element, the geometry of the component and the geometric arrangement of the nozzle outlet openings are interrelated to determine the optimum nozzle shape.

In this context, a triggering device is an element of the nozzle which is configured to activate, i.e. trigger, the supply of extinguishing fluid to the nozzle. For this purpose, such a triggering device may in particular comprise a closing element which, in the closed, i.e. non-triggered, state, is in a closing position in which a nozzle connection opening of the extinguishing fluid supply line is closed such that no extinguishing fluid can enter the nozzle. In the triggered state, the closing element is moved from the closing position to an opening position in which the closing element releases the extinguishing fluid flow from the extinguishing fluid supply line through the nozzle connection opening.

For this purpose, the triggering device may further comprise a triggering element, in particular a thermal or electrical triggering element, which holds the closing element in the closing position. In some embodiments, the triggering element is preferably implemented like a temperature-sensitive element of a sprinkler. For example, the triggering element can be implemented as a glass ampoule filled with liquid, where the liquid inside the glass ampoule heats up and expands in the event of fire. This causes a bursting of the glass ampoule, i.e. the triggering of the triggering element.

In the event of this triggering, the closing element is no longer held in the closing position, but moves from the closing position into the opening position. This releases the fluid flow through the nozzle connection opening.

When the extinguishing fluid emerges from the nozzle connection opening, it gets onto the alignment element. The alignment element preferably has one or more directional surfaces, which give the extinguishing fluid a predetermined directional characteristic. For this purpose, the extinguishing fluid emerging from the nozzle connection opening is preferably directed onto a surface having a specific surface structure. The extinguishing fluid is directed in a certain direction by this surface structure and can thus be given a predetermined directional characteristic.

In a further development, the alignment element is implemented as an extinguishing fluid-conducting nozzle duct, which is configured to conduct the extinguishing fluid to the plurality of nozzle outlet openings.

In some embodiments, the alignment element is implemented in particular as a fluid-tight duct. In this embodiment, the nozzle outlet openings are preferably implemented as openings in the duct. In this case, as well, the nozzle outlet openings may be arranged at the top and/or bottom and/or sides of the duct. The duct may have a ring-shaped cross-section. Alternatively, the cross-section may be rectangular, square, triangular or similar. The geometry of the cross-section of the duct is preferably adapted to the requirements of the component to be protected.

The fluid-tight duct is preferably connected via the nozzle connection opening to an extinguishing fluid supply, in particular to the extinguishing fluid supply line of the component. If the triggering element is triggered and the closing element correspondingly moves from the closing position to the opening position, the fluid flow through the nozzle connection opening is released and the extinguishing fluid enters the nozzle duct. The extinguishing fluid is conducted via the nozzle duct to the nozzle outlet openings and is discharged from the nozzle through these openings. This embodiment is particularly suitable in cases where there is a comparatively low pressure in the extinguishing fluid supply line of the component.

In another embodiment, the nozzle is arranged on or in the vicinity of a bottom side of the housing.

In some embodiments, the nozzle is preferably arranged on or in the vicinity of the bottom side of the component or housing. In this respect, the bottom side is the side of the component, or housing, that is directly opposite a floor surface above which the component is arranged. The component also has a top side which, starting from the floor surface, is further away from the floor surface. In a closed room, the top side is opposite the ceiling surface.

The nozzle is preferably arranged on the bottom side of the housing—and thus on the bottom side of the component—or in the vicinity of the bottom side. This embodiment is based on the knowledge that if the nozzle is arranged on the top side of the housing the latter forms a kind of fluid shadow for the extinguishing fluid emerging from the nozzle. This means that the extinguishing fluid cannot be distributed evenly over the component. In particular, the fluid shadow prevents the extinguishing fluid from being distributed to the bottom side of the component and to the area below the component, that area being closer to the floor surface.

This is particularly problematic if this area is the first to heat up in the event of fire. In some particularly unfavorable events of fire, the fire develops directly under the component or in the immediate vicinity of the component. In these cases, the area below the component and in the lower part of the component requires particularly adequate cooling. This cooling can be achieved by arranging the nozzle on or in the vicinity of the bottom side. Here, the nozzle preferably has an outlet characteristic that directs the extinguishing fluid to the bottom side and to the sides of the component. This allows for efficient cooling and thus for limiting the temperature increase. It is also possible to equip the component with at least one nozzle arranged at or in the vicinity of the bottom side of the housing and at least one nozzle arranged at or in the vicinity of the top side of the housing. This can improve the cooling even further.

According to another preferred embodiment, the fire protection system comprises a fire extinguishing system, in particular a sprinkler system, where the nozzle may be connected to the extinguishing fluid supply of the fire extinguishing system.

In one embodiment, the fire protection system has at least one fire extinguishing system. As mentioned in the introduction, fire extinguishing systems are permanently operational systems which serve to extinguish fires by means of an extinguishing fluid. Fire extinguishing systems may be designed in various ways and use a variety of extinguishing fluids. Examples of such systems include water extinguishing systems in which the extinguishing fluid comprises water, powder extinguishing systems which use powder as extinguishing agent, or gas extinguishing systems which use, for example, inert gases or carbon dioxide as extinguishing fluid.

A fire extinguishing system within the meaning of the invention may be implemented in particular as a sprinkler system. Sprinkler systems are a form of automatically functioning water extinguishing systems. They have a sprinkler pipe network that supplies a large number of sprinklers with the extinguishing fluid. Each of these sprinklers is sealed with a temperature-sensitive element, such as a glass ampoule. When there is no incident of fire, the temperature-sensitive elements maintain their shape and/or position, thus keeping all sprinklers closed and thereby maintaining a constant pressure of the extinguishing fluid within the pipe network. In the event of fire, the temperature-sensitive elements located near the source of the fire heat up and thus change their shape and/or position—for example, the glass ampoules burst—allowing extinguishing fluid to emerge from the corresponding sprinkler or sprinklers. This emergence of extinguishing fluid leads to a pressure drop in the pipe network. The pressure drop then leads to the opening of the above-mentioned alarm valves—which must accordingly retain their functionality during a fire—and, if applicable, to the activation of further components such as pumps or similar. This in turn leads to further extinguishing fluid being fed into the pipe network, through which the extinguishing fluid is passed at high pressure and then exits through all open sprinklers. This can prevent or minimize the spreading of the fire.

A commonality all fire extinguishing systems share is that they have an extinguishing fluid supply that serves to supply the fire extinguishing system with extinguishing fluid. It is preferred that the nozzle on the component for the fire protection system, which comprises the fire extinguishing system, is supplied by the extinguishing fluid supply of the fire extinguishing system. This eliminates the need to provide an additional, external extinguishing fluid supply for the nozzle. This has the advantage that manufacture is simplified, since the component or the housing of the component only has to be equipped with an extinguishing fluid inlet and/or an extinguishing fluid connection for connecting to the extinguishing fluid supply and can then be directly integrated into the system. Thus, there is no need to manufacture an additional extinguishing fluid supply and other components and elements that ensure a reliable supply of extinguishing fluid to the component.

In another preferred embodiment of the component, the nozzle is connected to a switching element which is configured to close when a predetermined pressure threshold is exceeded, the component being connected to an alarm element which is configured to output an alarm in response to the closing of the switching element.

The embodiments described above provide for triggering of the nozzle and thus cooling of the component in the event of fire. It is preferred that the component, preferably the nozzle, also has an alarm function. For this purpose, the component for a fire protection system may further comprise a switching element, in particular a pressure switch, which is located within the component, in particular within a fluid connection between the extinguishing fluid inlet and an extinguishing fluid outlet within the component. Alternatively or additionally, the switching element may also be located within a duct that serves to supply the component with extinguishing fluid, or within a dedicated and/or external alarm line. The switching element is preferably configured in such a way that it switches from a first switching position to a second switching position when the pressure acting on it changes—i.e. when the pressure within the fluid connection and/or the duct and/or the alarm line changes.

It is particularly preferred that the switching element reacts when a predetermined pressure threshold value is exceeded. It is further preferred that the switching element closes in response to the pressure threshold value being exceeded. This causes the output of a signal which is transmitted to an alarm element which triggers a corresponding alarm in response to this signal.

In the locked state, the fluid connection and/or the duct and/or the alarm line are under atmospheric pressure. If, as a result of the opening of a locking element and/or a closing element, the water flows into the fluid connection and/or the duct and/or the alarm line, a water pressure is created, i.e. a change in pressure occurs. In this respect, the pressure threshold value for triggering the switch must be selected according to the characteristics of the fire protection system. The switching element preferably switches at a threshold value of 0.55 bar.

Alternatively, the switching element can be configured to be closed during normal operation and only open when the pressure threshold value is exceeded. In this case, the opening of the switching element causes a signal that serves to trigger the alarm element.

The alarm element may be arranged directly on the component. Alternatively or in addition, the fire protection system may also comprise a separate alarm element. In particular, the alarm element may be configured to output an audible and/or visible signal.

In a further preferred embodiment, the component is designed as an extinguishing fluid-conducting component for a fire protection system, in particular a fire extinguishing system, the component comprising the extinguishing fluid inlet and also an extinguishing fluid outlet which is connected to the extinguishing fluid inlet in a fluid-conducting manner. In a preferred further development of this embodiment, the extinguishing fluid inlet is connected to the nozzle by a fluid duct running inside the component.

According to one embodiment, the component for the fire protection system is an extinguishing fluid-conducting component, i.e. a component through which the extinguishing fluid for the fire protection system is conducted. For this purpose, the component comprises an extinguishing fluid inlet as described above, i.e. an inlet, such as an opening in the housing of the component, through which the extinguishing fluid can enter the component and which can be equipped with a seal and/or fitting to ensure a fluid-tight connection to a extinguishing fluid supply.

Furthermore, the extinguishing fluid-conducting components have an extinguishing fluid outlet which is connected to the extinguishing fluid inlet in a fluid-conducting manner. The extinguishing fluid outlet is a further opening in the housing of the component—such opening being arranged in the direction of flow of the extinguishing fluid—through which the extinguishing fluid can exit the component again. The extinguishing fluid outlet may also be equipped with a seal and/or connecting piece to ensure a fluid-tight connection to the extinguishing fluid supply of the fire protection system, in particular to the extinguishing fluid supply of the sprinklers and/or extinguishing nozzles of a fire extinguishing or spark extinguishing system.

The extinguishing fluid inlet and the extinguishing fluid outlet are connected to each other in a fluid-conducting manner. This fluid-conducting connection may be provided in particular by a main chamber running inside the component from the extinguishing fluid inlet to the extinguishing fluid outlet in the direction of flow of the extinguishing fluid. Preferably, the main chamber has a locking element which interrupts the connection between the extinguishing fluid inlet and the extinguishing fluid outlet in a locking position, thus dividing the main chamber into a separate fluid inlet chamber on the extinguishing fluid inlet side and a separate fluid outlet chamber on the extinguishing fluid outlet side. In an unlocking position, the fluid inlet chamber and the fluid outlet chamber are connected in a fluid-conducting manner. Thus, in the locking position, no extinguishing fluid can flow from the extinguishing fluid inlet to the extinguishing fluid outlet. In the unlocking position, however, the extinguishing fluid can flow from the extinguishing fluid inlet to the extinguishing fluid outlet.

Extinguishing fluid-conducting components are used in particular in fire extinguishing systems, but also in spark extinguishing systems. In this context, fire extinguishing system valves should be mentioned as an example of such extinguishing fluid-conducting components. Fire extinguishing system valves within the meaning of the invention are to be understood in particular as the class of both passive and active alarm valves for use in fire extinguishing systems, especially fire extinguishing systems with water-based extinguishing agents (for example water, water with additives, etc.). The best-known examples of these alarm valves are wet and dry alarm valves and spray water valves.

In this context, a passive alarm valve is understood to be a valve which opens automatically when predetermined pressure differences between the extinguishing fluid inlet and the extinguishing fluid outlet are exceeded, i.e. a valve which moves the locking element automatically from the locking position into the unlocking position.

Here, in response to the detection of an open state of the valve, an alarm is usually triggered by the valve, for example, by means of a switching element arranged in an external alarm line, in particular a pressure switch, which then controls an alarm element, for example, an electrically operated alarm horn. Alternatively or in addition, the alarm may also be triggered by controlling the flow of extinguishing agent to a hydraulically operated alarm element—such as a water-operated alarm bell—connected to the alarm valve in fluid-technical manner.

An active alarm valve is a valve which, after receiving a corresponding signal from external fire detection means, such as the fire detectors mentioned before, or as a function of external control interventions, actively releases the fluid flow by opening the locking element and triggers an alarm.

If the nozzle is arranged on such an extinguishing fluid-conducting component, it is advantageous if the nozzle is supplied with extinguishing fluid directly via the extinguishing fluid inlet of the component. For this reason, the nozzle is implemented to be connectable to the extinguishing fluid supply of the fire protection system. Such a connection may be realized in particular by a fluid supply line from the extinguishing fluid inlet to the nozzle.

Preferably, the nozzle may be supplied by a fluid duct running inside the component, the duct connecting the extinguishing fluid inlet of the component and the nozzle in a fluid-conducting connection. In this respect, it is particularly preferred that the nozzle is arranged in such a way that the fluid duct can be designed as a branch line off of the main chamber, which connects the extinguishing fluid inlet with the extinguishing fluid outlet of the component in a fluid-conducting manner. The nozzle may preferably be positioned on the same surface of the component as the extinguishing fluid outlet. In this case, the fluid duct may be implemented as an L-shaped duct within the component.

The advantage of this design is that no additional supply of extinguishing fluid to the nozzle and no external connecting pieces are required to supply the nozzle. Rather, the nozzle can be supplied directly with the extinguishing fluid conducted through the component via a fluid connection running within the component. This saves manufacturing costs and reduces the weight of the component. In a preferred embodiment, the fluid duct may be designed in such a way that it connects the nozzle with the fluid inlet chamber and the extinguishing fluid inlet, on the one hand, and with the fluid outlet chamber and the extinguishing fluid outlet, on the other hand, in a fluid-conducting manner. Thus, in this case, the extinguishing fluid is not only conducted to the nozzle via the fluid duct, but can also be conducted away from it.

In the case that the component is an extinguishing fluid-conducting component, there is also the additional advantage that by conducting the extinguishing fluid through the component, it is not only cooled by the extinguishing fluid being dispensed through the nozzles onto and into the vicinity of the component, but also from the inside by the extinguishing fluid flowing through it. This results in an improved cooling effect.

In another preferred further development of this embodiment, the fluid duct comprises at least one valve element.

Advantageously, the fluid channel is also protected by a valve element. The valve element may preferably be arranged in a section that connects the fluid inlet chamber of the component with the fluid duct or with the fluid conducting connection to the nozzle. In particular, the valve element may be arranged at the inlet of the fluid duct. In this implementation, the valve element may preferably be designed as a non-return valve, which is set up in such a way that the extinguishing fluid can flow from the fluid inlet chamber into the fluid duct, but cannot exit it in the direction of the fluid inlet chamber. The non-return valve is therefore preferably used to open the junction from the fluid inlet chamber to the fluid duct in the direction of the nozzle and to close that junction in the opposite direction.

This embodiment ensures that the fluid duct is always filled with extinguishing fluid and thus the nozzle can be safely supplied with extinguishing fluid in the event of fire.

Alternatively or additionally, however, the valve element or an additional valve element may be arranged at a different location in the fluid duct. If the fluid duct has a supply line to the fluid outlet chamber, a valve element may also be arranged in the connecting section with the fluid outlet chamber. The valve element is preferably configured to lock the connection between the fluid duct and the fluid outlet chamber when the locking element is in a locking position and to open the connection when the locking element moves into the unlocking position. This ensures that the fluid duct supplying the nozzle is part of the extinguishing fluid circuit when the locking element is moved into the unlocking position and the extinguishing fluid supply is opened.

In an alternative embodiment, the component is implemented as a not-extinguishing fluid-conducting component, where the extinguishing fluid inlet, which is connected to the nozzle in a fluid-conducting manner, can be connected to the extinguishing fluid supply via an external connecting element. In a preferred further development of this embodiment, the extinguishing fluid inlet has a connection element which is connectable to the external connecting element.

In a further embodiment of the invention, the component for the fire protection system is a component through which no extinguishing fluid is conducted. Such components in particular may be electronic components, such as control cabinets, gears, measuring instruments, pumps or fire detectors, which must continue to function even in the event of fire. These components are advantageously implemented as encased components. This means that the housing serves to encase the corresponding internal electronic components. According to the invention, the housing must thus in particular be able to protect the interior of the components against the ingress of the extinguishing fluid. It is therefore preferable that the components are at least splash-proof, in particular protected against splash water from all sides with increased pressure. In this case, the housing is preferably manufactured at least according to IP protection class IP54.

Since the interior of the component contains electronic components in this embodiment, it is preferred in this case that the extinguishing fluid is not conducted to the nozzle through the interior of the component or the interior of the housing. Instead, the fluid supply from the extinguishing fluid supply to the nozzle should be provided outside the housing, especially along the housing. This extinguishing fluid supply may be designed separately and only serve to supply the nozzle. Alternatively, the extinguishing fluid supply to the nozzle may also be provided via the extinguishing fluid supply of the fire protection system, if available.

According to the invention, for this purpose, an extinguishing fluid inlet is preferred through which the extinguishing fluid cannot enter the interior of the component where the electronic components are located. In one embodiment, the housing may in particular comprise a dedicated nozzle connection area that is physically separated from the rest of the component and comprises the extinguishing fluid inlet and a corresponding fluid duct. The extinguishing fluid inlet is then connected to the extinguishing fluid supply by means of an external connecting element. Such a connecting element may be formed as a pipe or hose, for example. It must be taken into account that the material from which the pipe or hose is made should be as fire-resistant as possible to ensure the supply of the nozzle in the event of fire.

It is preferable that the connecting element and the extinguishing fluid inlet may be connected to each other in a fluid-tight manner. For this purpose, the extinguishing fluid inlet has a connection element which is preferably designed as a seal. Alternatively or additionally, the connecting element may also have a seal. By sealing the connection between the connecting element and the extinguishing fluid inlet, it is possible to prevent that extinguishing fluid from the extinguishing fluid supply gets onto the component when there is no fire.

The nozzle is supplied by feeding the extinguishing fluid through the connecting element into the extinguishing fluid inlet. The extinguishing fluid passes through the extinguishing fluid inlet and is conducted to the nozzle via the fluid duct. For this purpose, the nozzle is preferably arranged in the nozzle connection area. For this, it is advantageous if the nozzle connection area and/or the nozzle also have one or more seals. This ensures that in the event of fire, the extinguishing fluid exits with high pressure from the opening of the nozzle and cannot emerge beforehand through the connection between the nozzle and the nozzle connection area.

The invention has been described above by means of a first aspect with reference to the component for the fire protection system itself.

However, the invention also relates in a further aspect to a nozzle for a component of the aforementioned type, comprising: a plurality of nozzle outlet openings, at least one triggering device and one alignment element, the plurality of nozzle outlet openings being arranged in a geometrically predetermined arrangement on the alignment element. In a further development of this embodiment, the alignment element is implemented as an extinguishing fluid-conducting nozzle duct, which is configured to conduct the extinguishing fluid to the plurality of nozzle outlet openings.

The nozzle according to the invention makes use of the advantages and preferred embodiments of the component according to the invention. The preferred embodiments and further developments of the component are therefore at the same time preferred embodiments and further developments of the nozzle.

The invention relates in yet another aspect to a fire protection system, in particular a fire extinguishing system, comprising at least one component according to the embodiments described above.

The fire protection system according to the invention also makes use of the advantages and preferred embodiments of the component according to the invention. The preferred embodiments and further developments of the component are therefore at the same time preferred embodiments and further developments of the fire protection system, which is why reference is made to the above explanations in this respect.

In a further aspect, the invention relates to a method for manufacturing a component for a fire protection system. The method comprises the following steps: Arranging on a housing or in the vicinity of a housing at least one nozzle for applying extinguishing fluid to the component and connecting the nozzle to an extinguishing fluid supply. In a preferred further development, the method further comprises forming the housing wholly or partly from a material with a melting temperature of less than 800° C. In a further development, the method further comprises providing, within the component, an extinguishing fluid inlet and an extinguishing fluid outlet connected in a fluid-conducting manner to the extinguishing fluid inlet, and connecting the extinguishing fluid inlet to the nozzle by a fluid duct running inside the component.

The manufacturing method according to the invention also makes use of the advantages and preferred embodiments of the component according to the invention. The preferred embodiments and further developments of the component are therefore at the same time preferred embodiments and further developments of the manufacturing method, which is why reference is made to the above explanations in this respect.

In a further aspect, the invention further relates to a method for protecting a component for a fire protection system, where a housing of the component is at least partially formed from a material with a melting temperature of less than 800° C., the method comprising the following steps: Connecting a nozzle to an extinguishing fluid supply, providing, via the extinguishing fluid supply, an extinguishing fluid for application to the housing, and cooling the housing and/or the component at a temperature below the melting temperature by means of the extinguishing fluid.

According to this aspect, the extinguishing fluid is used to keep the housing of an extinguishing fluid-conducting component and/or the extinguishing fluid-conducting component as a whole below the melting temperature. Thus, cooling at a temperature below the melting temperature means that the extinguishing fluid should keep the temperature value of the housing and/or the component at a value below the melting temperature value.

In one aspect, the invention relates in particular to a method for protecting an extinguishing fluid-conducting component, in particular a valve, such as an alarm valve, which comprises an extinguishing fluid inlet and an extinguishing fluid outlet, the extinguishing fluid inlet and the extinguishing fluid outlet forming a fluid duct extending within the component, the method comprising the following steps: Arranging a nozzle on or in the vicinity of a housing of the component and supplying the nozzle with extinguishing fluid from the fluid duct. In a further development, the fluid duct may comprise a locking element which, in the locking state, defines a fluid inlet chamber and a fluid outlet chamber, the nozzle being connected in a fluid-conducting manner to the fluid inlet chamber in order to be supplied with extinguishing fluid from the fluid inlet chamber.

In a further aspect, the invention also relates to the use of a component according to one of the aforementioned embodiments in a fire protection system. In this case, as well, the preferred embodiments and further developments of the component are at the same time preferred embodiments and further developments of this aspect.

### BRIEF DESCRIPTION OF THE DRAWINGS

The invention is described in more detail below with reference to the attached figures and using preferred embodiment examples. The figures show:

FIG. 1 a component for a fire protection system according to a preferred embodiment in a schematic spatial view,

FIG. 2 the component according to FIG. 1 in a schematic spatial cross-sectional view,

FIG. 3 a component for a fire protection system according to another preferred embodiment in a schematic spatial view,

FIG. 4 a component according to FIGS. 1 and 2 in a further preferred embodiment,

FIG. 5 a component according to FIGS. 1, 2 and 4 in a further preferred embodiment,

FIG. 6 a nozzle according to a first preferred embodiment,

FIG. 7 the nozzle according to FIG. 6 in a schematic spatial cross-sectional view,

FIG. 8 a nozzle according to a second preferred embodiment,

FIG. 9 the nozzle according to FIG. 8 in a schematic spatial cross-sectional view, and

FIG. 10 a component according to FIGS. 1, 2, 4 and 5 in a further preferred embodiment.

### MODE(S) FOR CARRYING OUT THE INVENTION

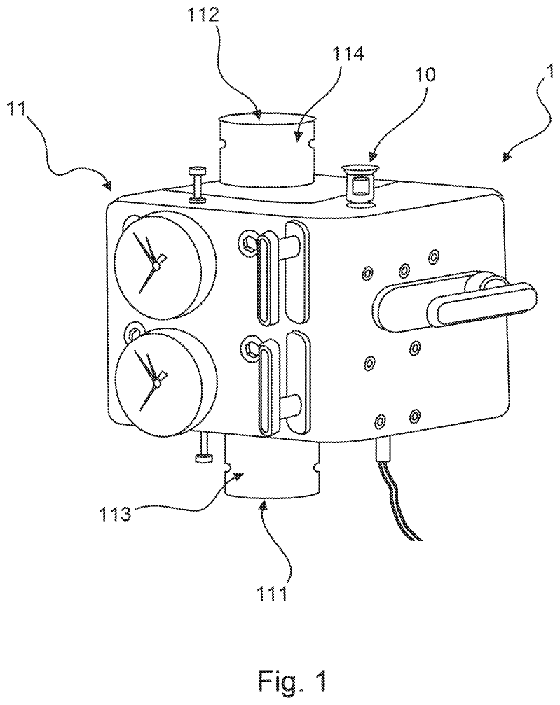

FIG. 1 shows a component 1 for a fire protection system 100 according to a first, preferred embodiment of the invention.

In this embodiment, the component 1 is implemented as an extinguishing fluid-conducting component in the form of a wet alarm valve. The component 1 comprises a nozzle 10, a housing 11, an inlet-side connecting socket 113 with the extinguishing fluid inlet 111 and an outlet-side connecting socket 114 with the extinguishing fluid outlet 112. The housing 11 and/or the inlet-side connecting socket 113 and/or the outlet-side connecting socket 114 are preferably at least partially made of a light metal or a plastic.

The nozzle 10 is implemented as an upright sprinkler arranged on the housing 11 and is supplied with extinguishing fluid through a fluid duct (not shown in FIG. 1) running inside the component 1. The arranging of the nozzle 10 on the housing 11 ensures that the extinguishing fluid emerging from the nozzle 10 in the event of fire can directly get onto the housing 11 and protect it accordingly.

The extinguishing fluid-conducting component 1 is connected to an extinguishing fluid supply of the fire protection system, in particular of a fire extinguishing system, by the inlet-side connecting socket 113. The inlet-side connecting socket 113 comprises an extinguishing fluid inlet 111 through which the extinguishing fluid enters the interior of the component 1.

Furthermore, the extinguishing fluid-conducting component 1 is connected to the extinguishing fluid supply of the fire protection system by an outlet-side connecting socket 114 and thus forms an element within the extinguishing fluid supply. The outlet-side connecting socket 114 comprises an extinguishing fluid outlet 112, through which the extinguishing fluid can exit the interior of the component 1 again in order to get to other components of the fire protection system, such as the sprinkler heads or extinguishing nozzles.

In the event of fire, the temperature in the vicinity of the nozzle 10 heats up. In this embodiment, in which the nozzle 10 is implemented as an upright sprinkler, this heating destroys the temperature-sensitive element and the nozzle 10 is triggered and applies extinguishing fluid onto the component 1 to protect it.

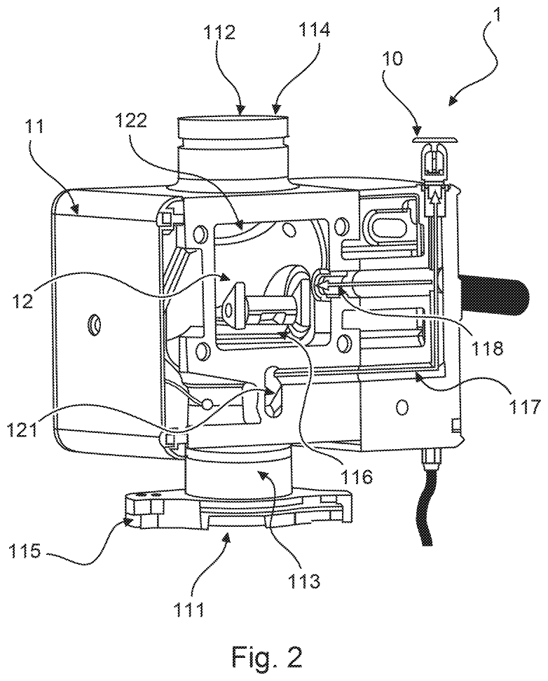

FIG. 2 shows the extinguishing fluid-conducting component 1 from FIG. 1 in a schematic spatial cross-sectional view.

The extinguishing fluid passes through the extinguishing fluid inlet 111 in the inlet-side connecting socket 113 from the extinguishing fluid supply of the fire protection system into the interior of the extinguishing fluid-conducting component 1. In order to create a fluid-tight connection between the inlet-side connecting socket and the extinguishing fluid supply of the fire protection system, the inlet-side connecting socket 113 comprises a connecting and sealing element 115, which connects a supply line of the extinguishing fluid supply with the inlet-side connecting socket 113.

Inside the component runs a main chamber 12, which is divided by the locking element 116 into a fluid inlet chamber 121 and a fluid outlet chamber 122. A fluid duct 117 runs from the fluid inlet chamber 121 of the main chamber 12 towards the nozzle 10 and thus connects the nozzle 10 with the extinguishing fluid supply of the fire protection system.

In the embodiment shown in FIG. 2, the fluid duct 117 comprises a supply line to the nozzle and further a discharge line towards the fluid outlet chamber 122, on which a valve element 118 is arranged. In the fluid inlet chamber 121, and thus also in the fluid duct 117 and at the nozzle 10, there is permanent water pressure (1 to 21 bar).

The fluid duct 117 acts as a bypass line, which is able to compensate for small pressure differences of about 15 l/min. As soon as the flow rate through the fluid duct 117 exceeds a flow rate of about 15 l/min, i.e. if the flow volume is higher than 15 l/min, the locking element opens and the alarm is triggered. The valve element 118 is designed as a non-return valve, which prevents the flowing back of possibly contaminated water, dead and stagnant water, from the sprinkler piping network and at the same time keeps the water available under pressure within the sprinkler piping network.

If the locking element 116 moves into the unlocking position, the extinguishing fluid can flow through the main chamber 12 from the extinguishing fluid inlet 111 towards the extinguishing fluid outlet 112 and then further through the fire protection system. For this purpose, the component 1 is integrated into the extinguishing fluid supply by the outlet-side connecting socket 114. The outlet-side connecting socket 114 also preferably has a sealing element such as a sealing ring to create a fluid-tight connection with the extinguishing fluid supply.

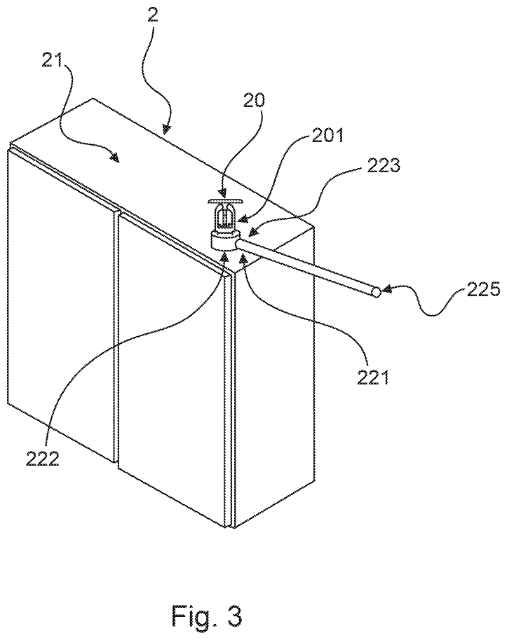

FIG. 3 shows a component 2 for a fire protection system according to another preferred embodiment.

The component 2 in FIG. 3 is a non-flammable component in the form of a switch cabinet for electronics. The not-extinguishing fluid-conducting component 2 comprises a nozzle 20 designed as an upright sprinkler for the self-protection of the component 2 and a housing 21.

The housing 21 comprises a nozzle connection area 222 for arranging the nozzle on the housing. The nozzle connection area 222 comprises an extinguishing fluid inlet 221 through which extinguishing fluid enters a fluid inlet chamber (not shown in FIG. 3) within the nozzle connection area 222, from where it is conducted to the nozzle 20. The nozzle connection area 222 is connected in a fluid-tight manner to an external connection element 225 via a connection element 223, which is preferably designed as a seal. The housing 21 and the nozzle connection area 222 are preferably made of a light metal or a plastic. The housing 21 should also be made splash-proof.

The external connecting element 225 is preferably implemented as a pipe or hose and is used to supply extinguishing fluid from an extinguishing fluid supply. This extinguishing fluid supply can either be a dedicated extinguishing fluid supply or an extinguishing fluid supply of a fire protection system.

In the event of fire, the area around the nozzle 20 heats up and triggers the nozzle 20. In this case, extinguishing fluid emerges from the nozzle 20 and is applied onto the component 20 to protect it during the fire.

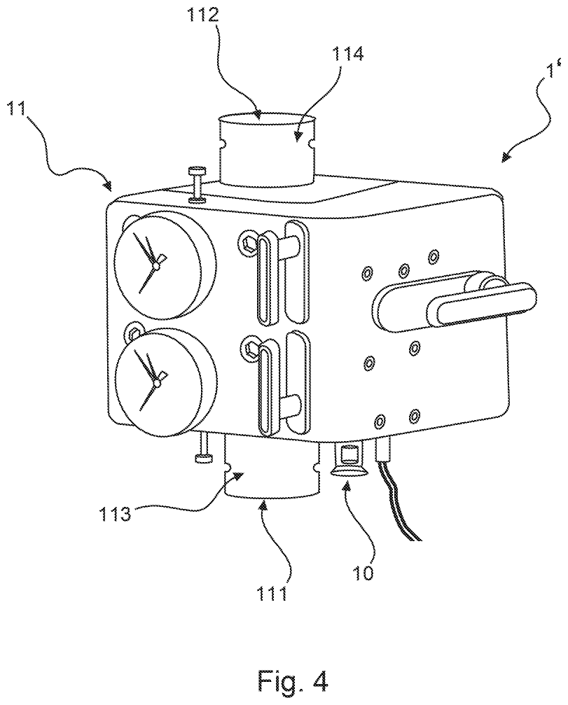

FIG. 4 shows an extinguishing fluid-conducting component 1′ according to a further preferred embodiment. The component 1′ as shown in FIG. 4 corresponds in large parts to the component 1 of FIG. 1, i.e. the component 1′ is also implemented in the form of a wet alarm valve. As already described in connection with FIG. 1, the component 1′ comprises a nozzle 10, a housing 11, an inlet-side connecting socket 113 with the extinguishing fluid inlet 111 and an outlet-side connecting socket 114 with the extinguishing fluid outlet 112, where the housing 11 and/or the inlet-side connecting socket 113 and/or the outlet-side connecting socket 114 are preferably at least partially made of a light metal or a plastic.

In contrast to the embodiment of FIG. 1, the nozzle 10 in the embodiment according to FIG. 4 is not implemented as an upright sprinkler arranged on the top side of the housing 11, but is arranged on the bottom side of the housing 11. Here, analogous to the embodiment of FIG. 1, the nozzle 10 is supplied with extinguishing fluid by a fluid duct running inside the component 1′.

The advantage of this embodiment, in which the nozzle 10 is arranged on the bottom side of the housing 11, is that—unlike in some embodiments in which the nozzle 10 is arranged on the top side of the housing 11—in the present case, the housing 11 cannot create on its bottom side a fluid shadow for the extinguishing fluid, which could cause the extinguishing fluid not to be distributed everywhere along the housing 11 and could lead to an increase in the temperature of the housing 11 (and the other parts of the component 1) in the places where the extinguishing fluid does not reach. This increase in temperature can thus be limited by arranging the nozzle on the bottom side.

In another preferred embodiment, the component 1′ may also be modified to have at least one nozzle 10 on the top side and at least one nozzle 10 on the bottom side. This enables even better cooling, as the nozzle 10, which is arranged on the top side, cools the component 1′ from above and the nozzle 10, which is arranged on the bottom side, cools the component 1′ from below.

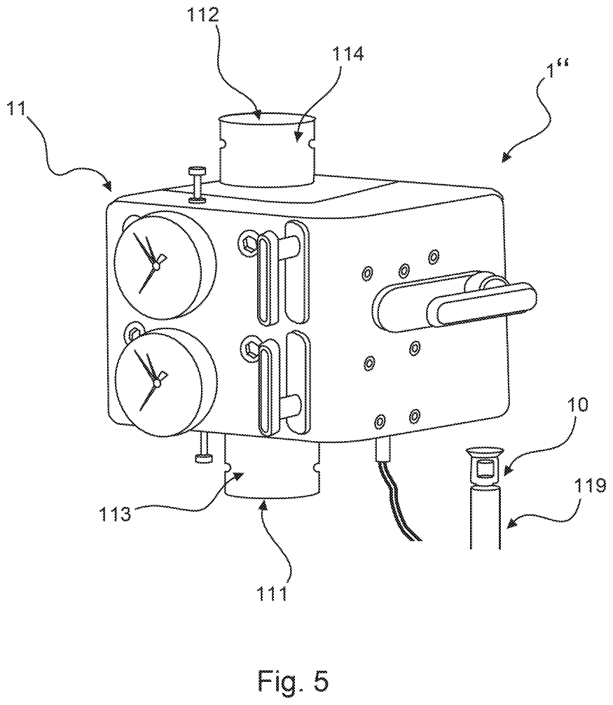

FIG. 5 shows a modification of the embodiment according to FIG. 4. In order to avoid repetition, we will not go into the individual details of the component 1″ below, which correspond to those of the component 1 and 1′ according to FIG. 1 and FIG. 4, but will rather point out the differences to the previous figures.

In the embodiment according to FIG. 5, the at least one nozzle 10 is not arranged on the housing 11 itself, but in the vicinity of the housing 11. In the specific embodiment of FIG. 5, the nozzle 10 is arranged in the vicinity of the bottom side of the housing 11. In other embodiments, however, the nozzle 10 can also be positioned in the vicinity of the top side of the housing 11 and/or—starting from the top and bottom side—in the vicinity of the middle of the housing 11 or at other positions. Other ways of arranging are conceivable. It is also possible to arrange several nozzles 10 in the vicinity of the housing 11 in this way.

In the embodiment of FIG. 5, the nozzle 10 is connected to a nozzle extinguishing fluid supply 119, which is used to supply the nozzle 10 with extinguishing fluid. The nozzle extinguishing fluid supply 119 can preferably be implemented as part of the extinguishing fluid supply of the fire protection system. This means that the nozzle 10 is supplied with extinguishing fluid via the nozzle extinguishing fluid supply 119, the extinguishing fluid being conducted directly from the extinguishing fluid supply of the fire protection system. In this way it can be ensured that there is always enough extinguishing fluid available. In other embodiments, the nozzle extinguishing fluid supply 119 may also be designed as an additional nozzle extinguishing fluid supply which is independent of the extinguishing fluid supply of the fire protection system.

Providing a nozzle 10 in the vicinity of the housing 11 allows in particular for a better distribution of the extinguishing fluid for cooling the component 1″. In some embodiments, the nozzle 10 in the vicinity of the housing 11 can also be combined with one or more nozzles 10 arranged on the housing 11.

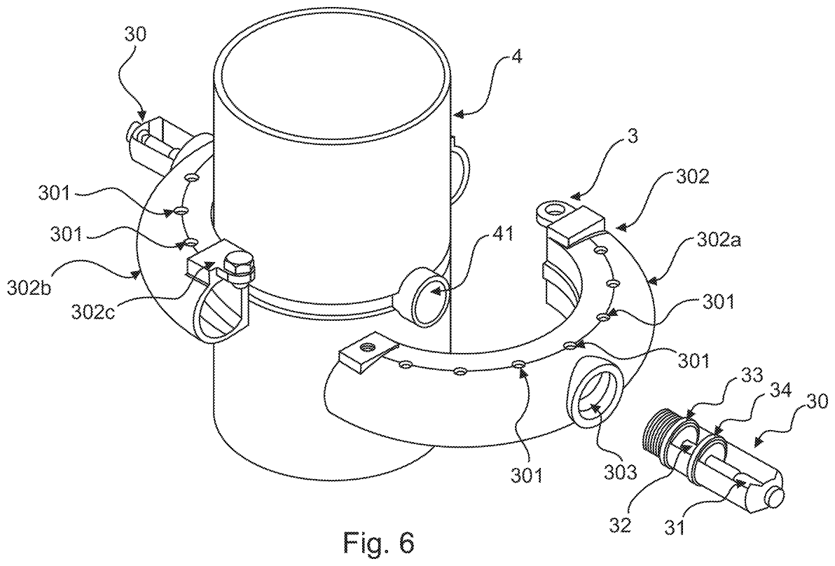

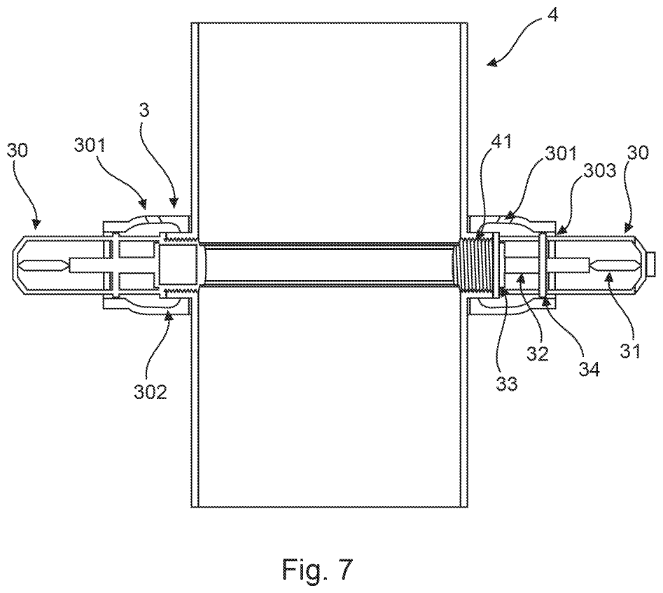

FIG. 6 shows a schematic exploded view of a nozzle 3 according to one aspect of the present invention. The nozzle 3 comprises a plurality of nozzle outlet openings 301, an alignment element 302 and two triggering devices 30. The nozzle 3 is arranged on an extinguishing fluid supply line 4 of a component. For this purpose, the extinguishing fluid supply line 4 of the component comprises at least one nozzle connection opening 41, the principle of which is explained in more detail in connection with FIG. 7.

In the specific embodiment of FIG. 6, the alignment element 302 is composed of two individual elements 302a and 302b, which are connected in a fluid-tight manner by means of the connecting elements 302c, which are designed as screws in FIG. 6. The nozzle outlet openings 301 are arranged on the top side of the alignment element 302 (and thus on the top side of the nozzle 3) in the embodiment of FIG. 6. Alternatively or additionally, the nozzle outlet openings 301 may also be arranged on the bottom side of the alignment element 302.

The alignment element 302 also has several openings 303, of which only one is shown in FIG. 6. These openings 303 serve to accommodate the triggering devices 30. Here, the triggering device 30 is inserted into the opening 303 and arranged in the opening 303 in such a way that the triggering device 30 closes the opening 303 in a fluid-tight manner.

This principle is once again schematically illustrated in FIG. 7, which shows a cross-sectional view of the nozzle according to the embodiment of FIG. 6. In FIG. 7, the triggering device 30 is arranged in the opening 303 and the nozzle connection opening 41. The triggering device 30 is implemented in such a way that the opening 303 is in fluid-tight connection with the triggering device 30. Furthermore, the nozzle connection opening 41 is also in fluid-tight connection with the combination of alignment element 302 and triggering device 30.

As FIG. 6 and FIG. 7 further show, the triggering devices comprise a triggering element 31 and a locking element 32. In the specific embodiment, the triggering element 31 is implemented as a thermal triggering element. As shown in FIG. 7, the triggering element 31 holds the closing element 32 in a closing position 33, in which the closing element 32 closes the nozzle connection opening 41 in a fluid-tight manner and thus cuts the nozzle 3 off from being supplied with extinguishing fluid from the extinguishing fluid supply line 4. If the triggering element 31 triggers, i.e. bursts or is moved out of position in any other way, the locking element 32 is no longer held in the locking position but instead moves to the opening position 34. This releases the fluid flow through the nozzle connection opening 41. The extinguishing fluid thus passes through the nozzle connection opening 41 into the alignment element 302 in which it distributes itself. When the alignment element 302 is filled with extinguishing fluid, the extinguishing fluid then flows out through the nozzle outlet openings 301 on the top side of the alignment element 302.

The nozzle 3 according to the embodiment of FIG. 6 and FIG. 7 is particularly suitable for being arranged on or in the vicinity of a bottom side of a component. Here, the nozzle 3 may be arranged in particular on the extinguishing fluid supply line 4, which—in the case of an extinguishing fluid-conducting component—supplies the component with extinguishing fluid. The extinguishing fluid emerging from the nozzle outlet openings 301 is then directed towards the bottom side of the component and in this way cools both the housing 11 and the component itself, as well as the vicinity of the component. This makes it possible to manufacture the housing 11 wholly or partly from a material that has a lower melting temperature than materials known from prior art.

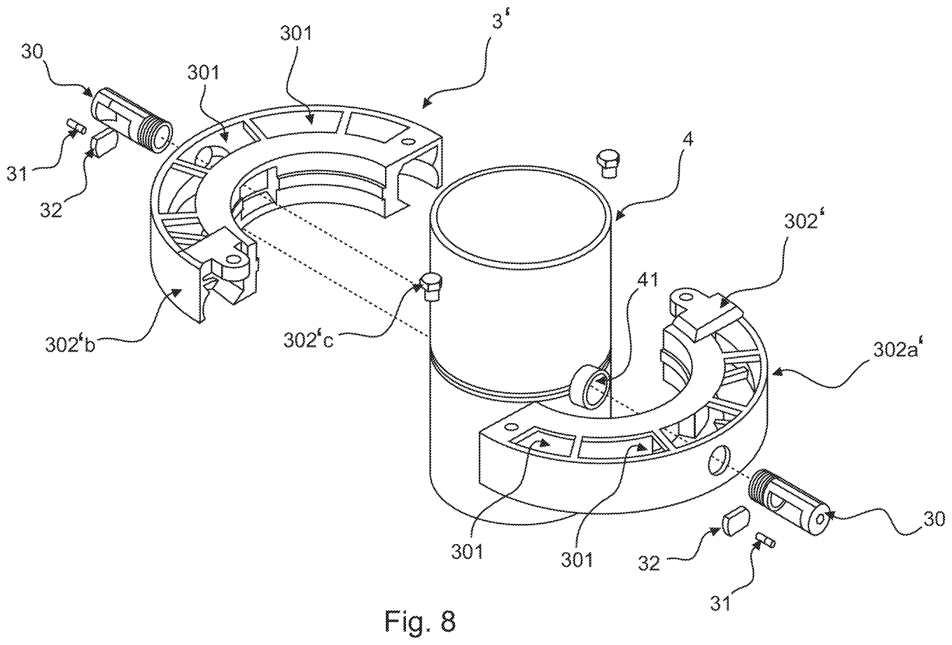

FIG. 8 shows a schematic view of a nozzle 3′ according to another preferred embodiment comprising several nozzle outlet openings 301 and two triggering devices 30. The functionality of the nozzle outlet openings 301 corresponds to the functionality as explained in connection with FIG. 6 and FIG. 7.

The principle of the triggering device 30 is also mostly analogous to the functionality as explained in connection with FIG. 6 and FIG. 7. In this embodiment, as well, the closing element 32 is held by the triggering element 31 in a closing position in which the fluid flow from the extinguishing fluid supply line 4 through the nozzle connection openings 41 is cut off by the closing element 32. However, in the embodiment of FIG. 8, the triggering of triggering element 31, which may again be designed as a thermal triggering element, has the effect that the closing element 32 is not moved into an opening position. Instead, the closing element 32 is disengaged and then “falls” out of the closing position to release the nozzle connection opening 41.

Preferably, the triggering device 30 is arranged on the alignment element 302′ or connected to it in such a manner that the triggering device 30, and in particular the triggering element 31, is unprotected to such an extent that it is directly exposed to any temperature changes in the area around the nozzle 3′, i.e. on the housing 11 or in the vicinity of the housing 11 of the component. This ensures a quick triggering of the nozzle 3′.

The alignment element 302′ also consists of two individual elements 302′a and 302′b, which are connected to each other by two connecting pieces 302′c, which are designed as screws in the specific embodiment. The embodiment of FIG. 8 differs decisively from the embodiment of FIG. 6 and FIG. 7 in particular in that the alignment element 302′ is not designed as a fluid-tight ring, but as a disc, which is opened at the top and bottom. This implementation of nozzle 3′ is particularly suitable in cases where the extinguishing fluid is conducted under high pressure into the extinguishing fluid supply line 4 and accordingly exits with high pressure from the nozzle connection opening 41 when this is opened.

Here, the openings of the disc serve as nozzle outlet openings 301 of the nozzle 3′, which comprises the alignment element 302′. The nozzle 3′ thus has nozzle outlet openings 301 at the top and bottom sides. However, the alignment element 302′ of the nozzle 3′ can also be implemented in such a way that the nozzle 3′ has nozzle outlet openings 301 only on the top side or only on the bottom side.

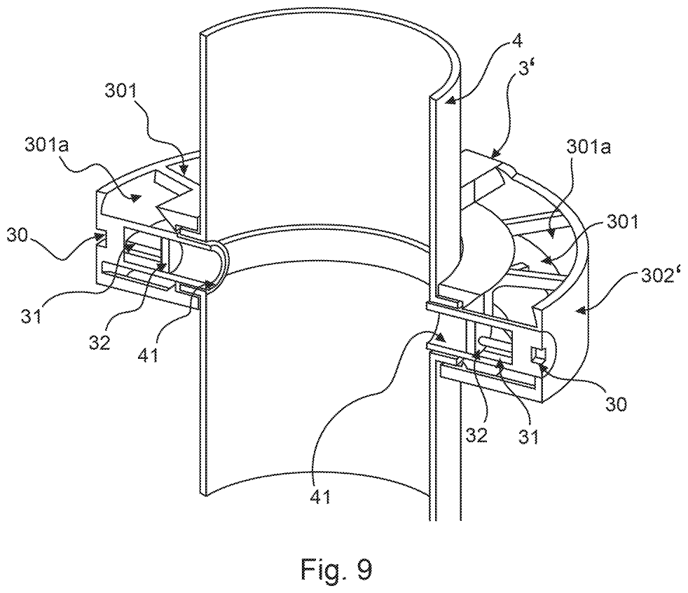

FIG. 9 shows the nozzle 3′ in a cross-sectional view. As FIG. 9 shows, the alignment element 302′ comprises several directional surfaces 301a, which are arranged inside the nozzle outlet openings 301 on the outer ring of the disc in the direction of the extinguishing fluid supply line 4. These directional surfaces 301a serve to align the extinguishing fluid conducted from the extinguishing fluid supply line 4 through the nozzle connection opening 41 into the nozzle along a certain directional characteristic after the nozzle 3′ has been triggered by the triggering device 30, in order to enable an optimum distribution of the extinguishing fluid on the component 10.

For this purpose, the directional surfaces 301a may be formed in different ways. In the embodiment of FIG. 9, for example, the directional surfaces 301a are rounded. In other embodiments, however, the directional surfaces 301a may also be formed as smooth surfaces, as wavy surfaces, in angular manner or according to other geometric designs. The size and surface form of the directional surfaces 301a should be selected with regard to the component to be protected, the position of the nozzle 3′ in relation to the component, and the pressure and composition of the extinguishing fluid.

In the embodiments of FIGS. 6 to 9, the nozzle 3, 3′ was arranged on the extinguishing fluid supply line 4 of a component such as the component 1, 1′ and 1″. This arranging can preferably be along the direction of the fluid upstream of the component 1, 1′, 1″—i.e. on the bottom side of the component 1, 1′, 1″—or in the direction of the fluid downstream of the component 1, 1′, 1″—i.e. on the top side of the component 1, 1′, 1″. The arranging on the extinguishing fluid supply line 4 means that the nozzle 3, 3′ is arranged at some distance from the component 1, 1′, 1″ in its vicinity.

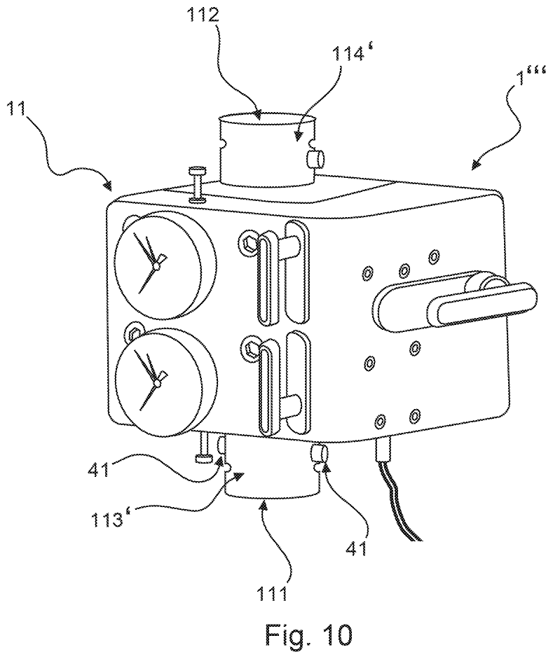

Alternatively or in addition, the nozzle 3, 3′ may also be arranged directly on the component. Such a component 1′″, which is suitable to enable the connection of a nozzle 3, 3′, is schematically shown in FIG. 10. The component 1′″ of FIG. 10 corresponds mostly to the components 1, 1′, 1″ as described in more detail in connection with FIGS. 1, 2, 4 and 5. To avoid repetition, we refer to the description of these Figures.

Unlike the components 1, 1′ and 1″ of FIGS. 1, 2, 4 and 5, the component 1′″ of FIG. 10 is suitable for connecting a nozzle 3, 3′. For this purpose, the component 1′″ comprises at least one nozzle connection opening 41. This at least one nozzle connection opening 41 is preferably arranged at the inlet-side connecting socket 113′ and/or at the outlet-side connecting socket pipe 114′. The nozzle 3, 3′ can then be arranged either at the inlet-side connecting socket 113′ or the outlet-side connecting socket 114′, as described in connection with FIGS. 6 to 9. Here, it needs to be noted that the embodiment of the nozzle 3, 3′ can be designed in accordance with the embodiment of FIG. 6 and FIG. 7 or in accordance with the embodiment of FIG. 8 and FIG. 9. A combination of both embodiments or a different embodiment may also be used. It is important at this point to adapt the arrangement of the nozzle 3, 3′ and the geometric arrangement of the nozzle outlet openings 301 and the triggering devices 30 to the respective conditions of the individual components.

### LIST OF UTILIZED REFERENCE NUMBERS

Component 1, 1′, 1″, 1′″, 2

Nozzle 10, 20, 3, 3′

Housing 11, 21

Main chamber 12

Fluid inlet chamber 121

Fluid outlet chamber 122

Extinguishing fluid inlet 111, 221

Extinguishing fluid outlet 112

Inlet-side connecting socket 113, 113′

Outlet-side connecting socket 114, 114′

Sealing element 115

Locking element 116

Fluid duct 117

Valve element 118

Nozzle connection area 222

Connection element 223

External connection element 225

Triggering device 30

Triggering element 31

Closing element 32

Locking position 33

Opening position 34

Nozzle outlet opening 301

Directional surfaces 301a

Alignment element 302, 302′

Individual element 302a, 302b, 302′a, 302′b

Connecting element 302c, 302′c

Opening 303

Extinguishing fluid supply line 4

Nozzle connection opening 41

1. A component for a fire protection system having a housing,
wherein at least one nozzle for dispensing extinguishing fluid onto the component is arranged on the housing or in the vicinity of the housing,
wherein the at least one nozzle is connectable to an extinguishing fluid supply.

2. The component according to claim 1, wherein the housing is formed wholly or partly from a material having a melting temperature of less than 800° C.

3. The component according to claim 2, wherein the housing is wholly or partly formed from a plastic and/or a light metal.

4. The component according to claim 1, wherein the component comprises an extinguishing fluid inlet which is connected to the at least one nozzle in a fluid-conducting manner.

5. The component according to claim 1,
wherein the at least one nozzle comprises a plurality of nozzle outlet openings, at least one triggering device and an alignment element,
wherein the plurality of nozzle outlet openings is arranged in a geometrically predetermined arrangement on the alignment element.

6. The component according to claim 5,
wherein the alignment element is implemented as an extinguishing fluid-conducting nozzle duct, which is configured to conduct the extinguishing fluid to the plurality of nozzle outlet openings.

7. The component according to claim 1,
wherein the at least one nozzle is arranged on or in the vicinity of a bottom side of the housing.

8. The component according to claim 1,
wherein the fire protection system comprises a sprinkler system; and
wherein the nozzle is connectable to the extinguishing fluid supply of the sprinkler system.

9. The component according to claim 1,
wherein the at least one nozzle is connected to a switching element which is configured to close when a predetermined pressure threshold value is exceeded,
wherein the component is connected to an alarm element which is configured to output an alarm in response to the closing of the switching element.

10. The component according to claim 1,
wherein the component is implemented as an extinguishing fluid-conducting component for a fire extinguishing system, wherein
the component comprises an extinguishing fluid inlet and further comprises an extinguishing fluid outlet which is connected to the extinguishing fluid inlet in a fluid-conducting manner.

11. The component according to claim 10,
wherein the extinguishing fluid inlet is connected to the at least one nozzle by a fluid duct running within the component.

12. The component according to claim 11,
wherein the fluid duct comprises at least one valve element.

13. The component according to claim 1,
wherein the component is implemented as a not-extinguishing fluid-conducting component,
wherein an extinguishing fluid inlet, which is connected to the at least one nozzle in a fluid-conducting manner, is connectable to the extinguishing fluid supply via an external connecting element.

14. The component according to claim 13,
wherein the extinguishing fluid inlet has a connection element, the connection element being connectable to the external connection element.

15. A nozzle for a component according to claim 14, comprising:
a plurality of nozzle outlet openings,
at least one triggering device, and
an alignment element,
wherein the plurality of nozzle outlet openings is arranged in a geometrically predetermined arrangement on the alignment element.

16. The nozzle according to claim 15,
wherein the alignment element is designed as an extinguishing fluid-conducting nozzle duct which is configured to conduct the extinguishing fluid to the plurality of nozzle outlet openings.

17. A fire protection system, comprising at least one component according to claim 1.

18. A method for manufacturing a component for a fire protection system, comprising:
arranging on a housing or in the vicinity of a housing at least one nozzle for dispensing extinguishing fluid onto the component; and
connecting the at least one nozzle to an extinguishing fluid supply.

19. The method according to claim 18, further comprising:
forming the housing wholly or partly from a material having a melting temperature of less than 800° C.

20. The method according to claim 18, comprising:
providing, within the component, an extinguishing fluid inlet and an extinguishing fluid outlet which is connected to the extinguishing fluid inlet in a fluid-conducting manner, and
connecting the extinguishing fluid inlet to the at least one nozzle by a fluid duct running inside the component.

21. A method for protecting a component for a fire protection system, wherein a housing of the component is at least partially formed from a material having a melting temperature of less than 800° C., the method comprising:
connecting a nozzle to an extinguishing fluid supply,
providing, via the extinguishing fluid supply, an extinguishing fluid for application onto the housing, and
cooling, by means of the extinguishing fluid, the housing and/or the component at a temperature below the melting temperature.

22. (canceled)
